(19) United States
(12) Patent Application Publication
(10) Pub. No.: US 2014/0153384 A1
(43) Pub. Date: Jun. 5, 2014

(54) ELECTRONIC DEVICE AND TRANSMISSION CONTROL METHOD

(71) Applicant: FUJITSU LIMITED, Kawasaki-shi (JP)

(72) Inventor: Katsuya Ishiyama, Kawasaki (JP)

(73) Assignee: FUJITSU LIMITED, Kawasaki-shi (JP)

(21) Appl. No.: 13/902,841

(22) Filed: May 26, 2013

(30) Foreign Application Priority Data
Jul. 13, 2012 (JP) 2012-157787

(51) Int. Cl. H04L 12/707; H04L 12/703

(52) U.S. Cl. CPC H04L 45/22; H04L 45/28
USPC 370/225

(57) ABSTRACT

A first component receives packets from a second component. When setting content related to a physical layer of a transmission path between the first component and the second component is reinitialized, the first component transmits identification information to the second component. This identification information identifies a packet to be received when packet transmission suspended due to the reinitialization is restarted. The second component transmits a packet to the first component and receives the identification information from the first component. After the reinitialization has been completed and before the packet transmission is restarted, the second component performs control such that the packet transmission is restarted in accordance with the identification information.

### CROSS-REFERENCE TO RELATED APPLICATION

This application is based upon and claims the benefit of priority of the prior Japanese Patent Application No. 2012-157787, filed on Jul. 13, 2012, the entire contents of which are incorporated herein by reference.

### FIELD

The embodiments discussed herein are related to an electronic device and a transmission control method.

### BACKGROUND

Conventional information processing apparatuses are configured from multiple components, such as processors. The components are connected with each other by at least one single lane and packets are transmitted and received via the lane.

If the quality of the transmission path between the components becomes worse and thus a packet is not correctly transmitted, reinitialization is performed in the physical layer. Examples of reinitialization of the physical layer include a change in the number of lanes in the transmission path or a change in the transmission speed. After the reinitialization is performed, the transmission side is not aware of how many packets the reception side has already received, and the reception side is not aware of how many packets the transmission side has already transmitted.

Consequently, after the reinitialization is performed and before a packet is transmitted and received, the reception side requests notification from the transmission side of the latest sequence number that has been transmitted and the transmission side accordingly notifies the reception side of the latest sequence number that has been transmitted. In this way, the reception side can specify the sequence number of a packet that has not been received and then request the transmission side to retransmit packets on the basis of the sequence numbers of the lost packets. This can be done using a known technology

Patent Document 1: Japanese Laid-open Patent Publication No. 2000-354082

Patent Document 2: Japanese Laid-open Patent Publication No. 2010-283427

However, with the conventional technology, because it takes a long time to start the retransmission of a packet and the delay time before the packet is correctly transmitted and received is long; therefore, there is a problem in that performance is degraded.

Furthermore, after reinitialization is performed in the physical layer, the transmission side may possibly retransmit, under the assumption that all of the packets have been received without performing processes described above, a packet whose transmission was suspended due to the reinitialization. However, if a packet that has already been transmitted is not received on the reception side, the reception side is not able to receive the expected packet before a replay time-out causes the transmission side to spontaneously start the retransmission; therefore, performance is degraded.

### SUMMARY

According to an aspect of an embodiment, an electronic device includes: a first component; and a second component, wherein the first component includes a receiving unit that receives a packet from the second component, an information transmitting unit that transmits, to the second component, when setting content related to a physical layer of a transmission path between the first component and the second component is reinitialized, identification information which identifies a packet that is to be received when a packet transmission suspended due to the reinitialization is restarted, and the second component includes a transmitting unit that transmits a packet to the first component, a receiving unit that receives the identification information from the first component, and a transmission control unit that controls, after the reinitialization has been completed and before the packet transmission is restarted by the transmitting unit, the transmitting unit such that the packet transmission is restarted in accordance with the identification information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating an example of the overall configuration of an information processing apparatus according to a first embodiment;

FIG. 2 is a block diagram illustrating the configuration of the information processing apparatus according to the first embodiment;

FIG. 3 is a schematic diagram illustrating the flow of a process from reinitializing to restarting packet transmission according to the first embodiment;

FIG. 4 is a sequence diagram illustrating the flow of a process according to the first embodiment;

FIG. 5 is a block diagram illustrating the configuration of an information processing apparatus according to a second embodiment;

FIG. 6 is a schematic diagram illustrating the flow of a process from reinitializing from reinitializing to restarting packet transmission according to the second embodiment;

FIG. 7 is a sequence diagram illustrating the flow of a process according to the second embodiment; and

FIG. 8 is a schematic diagram specifically illustrating a reinitializing process according to the second embodiment.

### DESCRIPTION OF EMBODIMENTS

Preferred embodiments will be explained with reference to accompanying drawings.

The present invention is not limited to the embodiment.

### [a] First Embodiment

### Overall Configuration

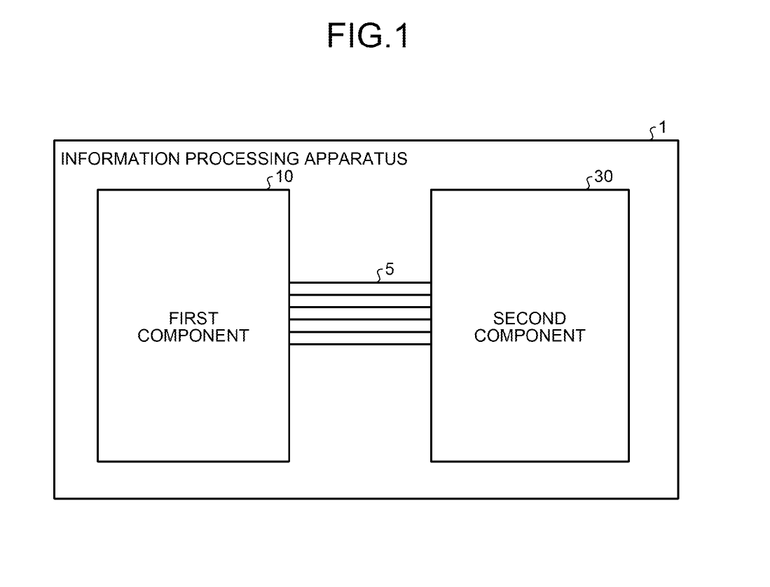

FIG. 1 is a schematic diagram illustrating an example of the overall configuration of an information processing apparatus according to a first embodiment. An information processing apparatus 1 is an example of an electronic device and includes, as illustrated in FIG. 1, a first component 10 and a second component 30. The number of components is not limited to that illustrated in FIG. 1. Furthermore, each of the components is also an example of an electronic device. In the first embodiment, a description will be given of a case in which the first component 10 is a reception-side device and the second component 30 is a transmission-side device; however, the configuration is not limited thereto. For example, the first component 10 may also be a transmission-side device and the second component 30 may also be a reception-side device.

Each of the first component 10 and the second component 30 are hardware, such as a processor, and the components are connected by at least one single transmission path (lane) 5. An identification number for identifying a lane is allocated to each of the lanes 5. If the first component 10 and the second component 30 are physically connected by the lanes 5, the first component 10 and the second component 30 initialize the physical layer, such as determining the transmission speed, to shift its state to a state in which communication is available. In the first embodiment, a description will be given of a case in which the first component 10 receives the packet that has been transmitted using serial communication by the second component 30. Furthermore, in the first embodiment, a description will be given of a case in which the second component 30 sequentially transmits packets starting from the sequence number 1.

With this configuration, the first component 10 receives a packet from the second component 30. When the setting content related to the physical layer of the lanes 5 is reinitialized, the first component 10 transmits, to the second component 30, identification information for identifying a packet that is to be received when the packet transmission suspended due to the reinitialization is restarted. Then, the second component 30 receives the identification information from the first component 10 and performs control such that, after the completion of the reinitialization and before restarting the packet transmission, the packet is retransmitted in accordance with the identification information.

As described above, after the reinitialization or during the reinitialization of the physical layer between the reception side and the transmission side, the information processing apparatus 1 can send, from the reception side to the transmission side as a notification, a restart time point of the packet transmission and can restart the transmission starting from the packet expected by the reception side. Consequently, it is possible to reduce the delay time before the packet is correctly transmitted and received, thus reducing degradation of performance.

Configuration of the Information Processing Apparatus

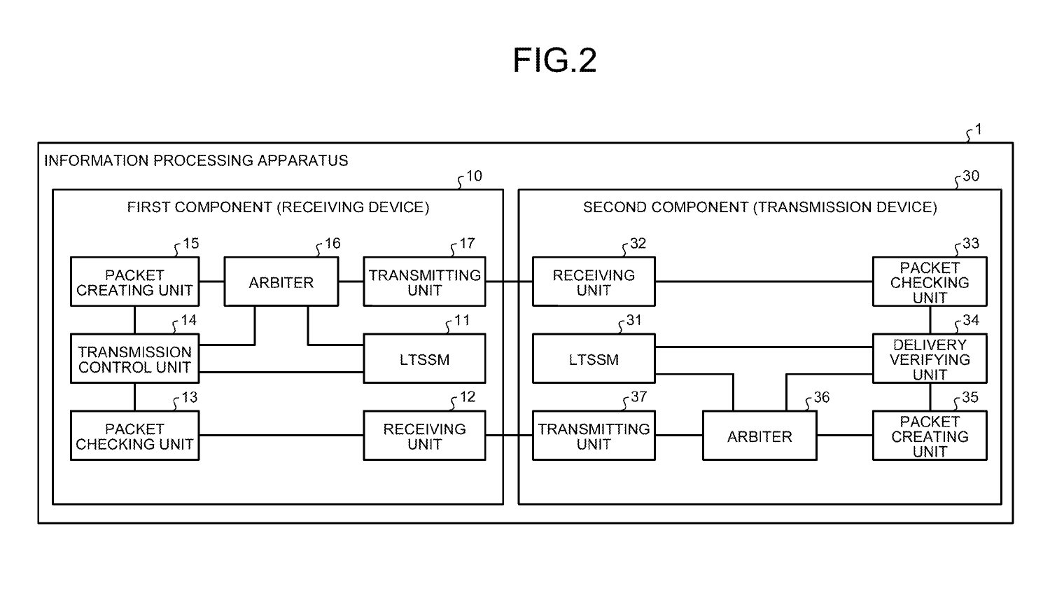

FIG. 2 is a block diagram illustrating the configuration of the information processing apparatus according to the first embodiment. In the following, the first component 10 and the second component 30 will be described.

Configuration of the First Component

As illustrated in FIG. 2, the first component 10 includes a Link Training and Status State Machine (LTSSM) 11, a receiving unit 12, a packet checking unit 13, a transmission control unit 14, a packet creating unit 15, an arbiter 16, and a transmitting unit 17. Each processing unit is implemented by, for example, hardware. The LTSSM 11, the receiving unit 12, and the transmitting unit 17 correspond to the physical layer. The packet checking unit 13, the transmission control unit 14, the packet creating unit 15, and the arbiter 16 correspond to the data link layer.

The LTSSM 11 manages a link between the first component 10 and the second component 30. For example, if link abnormality occurs, such as a reception error of a packet or a malfunction of the lanes 5, the LTSSM 11 initializes, for the transmission path between the first component 10 and the second component 30, the items to be set in the unit corresponding to the physical layer, i.e., initializes the physical layer. For example, if the first component 10 detects a link abnormality, the LTSSM 11 changes the number of lanes or changes the transmission speed. Furthermore, the LTSSM 11 notifies the transmission control unit 14 or the arbiter 16 of the starting and the end of the initialization of the physical layer.

The receiving unit 12 receives packets that have been transmitted by the second component 30. The receiving unit 12 receives a packet by each of the lanes 5 and outputs the received packet to the packet checking unit 13.

The packet checking unit 13 determines whether packets are received normally. Specifically, the packet checking unit 13 manages, as NXT_RCV, the sequence number of a packet that is expected to be subsequently received to be received and determines whether packets are sequentially received.

For example, if the packet checking unit 13 receives a packet with the sequence number 3 after a packet with the sequence number 1, the packet checking unit 13 discards the packet with the sequence number 3 and notifies the transmission control unit 14 that the reception state is abnormal.

Furthermore, if the packet checking unit 13 receives a packet with the sequence number 2 after receiving the packet with the sequence number 1, the packet checking unit 13 notifies a processing unit of the packet with the sequence number 2. Then, the packet checking unit 13 notifies the transmission control unit 14 that the reception state is normal and that the latest sequence number is 2.

The transmission control unit 14 then instructs that a transmission target be created by the packet creating unit 15. Specifically, the transmission control unit 14 instructs that a response packet be created with respect to the reception of a packet in accordance with the checked result performed by the packet checking unit 13. For example, if the packet checking unit 13 determines that a packet is normally received, the transmission control unit 14 outputs, to the packet creating unit 15, an instruction to create an ACK. For example, if the sequence number of a packet that has been normally received is 3, the transmission control unit 14 outputs, to the packet creating unit 15, an instruction to create an ACK with respect to the packet whose sequence number is 3.

Furthermore, after reinitialization of the setting content in the physical layer is performed, the transmission control unit 14 instructs that identification information be created that is used to identify a packet that is to be received when packet transmission suspended due to the reinitialization of the setting content is restarted. Specifically, if the transmission control unit 14 receives, from the LTSSM 11, a notification that the reinitialization of the physical layer has been completed, the transmission control unit 14 instructs that a NAK be created that is used to notify the sequence number of the packet that was received normally until the reinitialization was performed. For example, after the reinitialization of the physical layer has been completed, the transmission control unit 14 acquires NXT_RCV from the packet checking unit 13. Then, the transmission control unit 14 outputs, to the packet creating unit 15, both an instruction to create a NAK and a value obtained by subtracting 1 from a value of NXT_RCV.

The packet creating unit 15 creates a packet and outputs the packet to the arbiter 16. Specifically, the packet creating unit 15 creates a packet created by a processing unit (not illustrated) or creates an ACK or a NAK due to an instruction from the transmission control unit 14. For example, if the packet creating unit 15 receives, from the transmission control unit 14, an instruction to create an ACK with respect to the packet with the sequence number of 3, the packet creating unit 15 creates an ACK containing the sequence number “3” and outputs it to the arbiter 16. Furthermore, if the packet creating unit 15 receives, from the transmission control unit 14, both the value “4” obtained by subtracting 1 from NXT_RCV=5 and an instruction to create a NAK, the packet creating unit 15 creates a NAK by substituting 4 for aseq # and outputs the obtained value to the arbiter 16.

The arbiter 16 controls transmission of packets created by the packet creating unit 15. Specifically, if the arbiter 16 receives, from the LTSSM 11, a notification that the initialization of the physical layer has been completed, the arbiter 16 performs control such that a NAK is transmitted as a priority. For example, if the arbiter 16 receives an input of a NAK from the packet creating unit 15 in a state in which an ACK or another packet is input from the packet creating unit 15, the arbiter 16 gives priority to the NAK and outputs it to the transmitting unit 17.

The transmitting unit 17 then transmits the packet to the second component 30. For example, the transmitting unit 17 transmits, to the second component 30, the NAK that has been output by the arbiter 16 and that contains aseq # that specifies a reception target.

Configuration of the Second Component

As illustrated in FIG. 2, the second component 30 includes an LTSSM 31, a receiving unit 32, a packet checking unit 33, a delivery verifying unit 34, a packet creating unit 35, an arbiter 36, and a transmitting unit 37. Each processing unit is implemented by, for example, hardware. The LTSSM 31, the receiving unit 32, and the transmitting unit 37 correspond to the physical layer. The packet checking unit 33, the delivery verifying unit 34, the packet creating unit 35, and the arbiter 36 correspond to the data link layer.

Similarly to the LTSSM 11, the LTSSM 31 manages a link between the first component 10 and the second component 30. The LTSSM 31 performs the same processes as those performed by the LTSSM 11 described above; therefore, a description thereof in detail will be omitted.

The receiving unit 32 receives the packet that has been transmitted by the first component 10. The receiving unit 32 receives a packet by each of the lanes 5 and outputs the received packet to the packet checking unit 33. For example, the receiving unit 32 receives an ACK or a NAK and outputs it to the packet checking unit 33.

The packet checking unit 33 checks the sequence number contained in the received packet or a value of aseq # and outputs it to the delivery verifying unit 34. For example, the packet checking unit 33 extracts a sequence number from the received ACK or NAK.

The delivery verifying unit 34 determines whether the packet that was transmitted due to the reception of an ACK or the like is received normally. Furthermore, the delivery verifying unit 34 manages, as an ACKD, the sequence number of the latest packet whose transmission has been verified. The delivery verifying unit 34 manages, as an NXT_TR, the sequence number of a packet subsequent to the latest packet that has been transmitted.

Furthermore, if an NXT_TR is “8” and an ACK that is associated with the sequence number “7” is not received for a certain time period, the delivery verifying unit 34 determines that the packet with the sequence number “7” has not been received normally. Then, the delivery verifying unit 34 outputs, to the packet creating unit 35, an instruction to re-create the packet with the sequence number “7”.

Furthermore, if an NAK is received by the receiving unit 32 and a notification that aseq # is “7” is received from the packet checking unit 33, the delivery verifying unit 34 determines that packets with the sequence numbers up to “7” are received normally. Then, the delivery verifying unit 34 updates the ACKD to “7” and outputs, to the packet creating unit 35, an instruction to re-create a packet with the sequence number of “8”.

The packet creating unit 35 then creates a packet and outputs the packet to the arbiter 36. Specifically, the packet creating unit 35 creates a retransmission packet or a normal packet. For example, if the packet creating unit 35 receives, from the delivery verifying unit 34, a sequence number and an instruction to re-create a packet, the packet creating unit 35 creates a packet that contains the subject sequence number. Furthermore, if the packet creating unit 35 receives, from the delivery verifying unit 34, a sequence number and an instruction to re-create a packet, the packet creating unit 35 creates a retransmission packet that contains the subject sequence number.

The arbiter 36 controls transmission of the packets that have been created by the packet creating unit 35. Specifically, if the arbiter 36 receives, from the LTSSM 31, a notification that the initialization of the physical layer has been completed, the arbiter 36 controls the transmission such that the retransmission packet is transmitted with priority. For example, if the arbiter 36 receives a retransmission packet associated with a NAK from the packet creating unit 35 in a state in which a normal packet is input from the packet creating unit 35, the arbiter 36 gives priority to the retransmission packet and outputs it to the transmitting unit 37.

The transmitting unit 37 transmits the packet to the first component 10. For example, the transmitting unit 37 transmits, to the first component 10, the packet that has been output by the arbiter 36.

### Specific Example

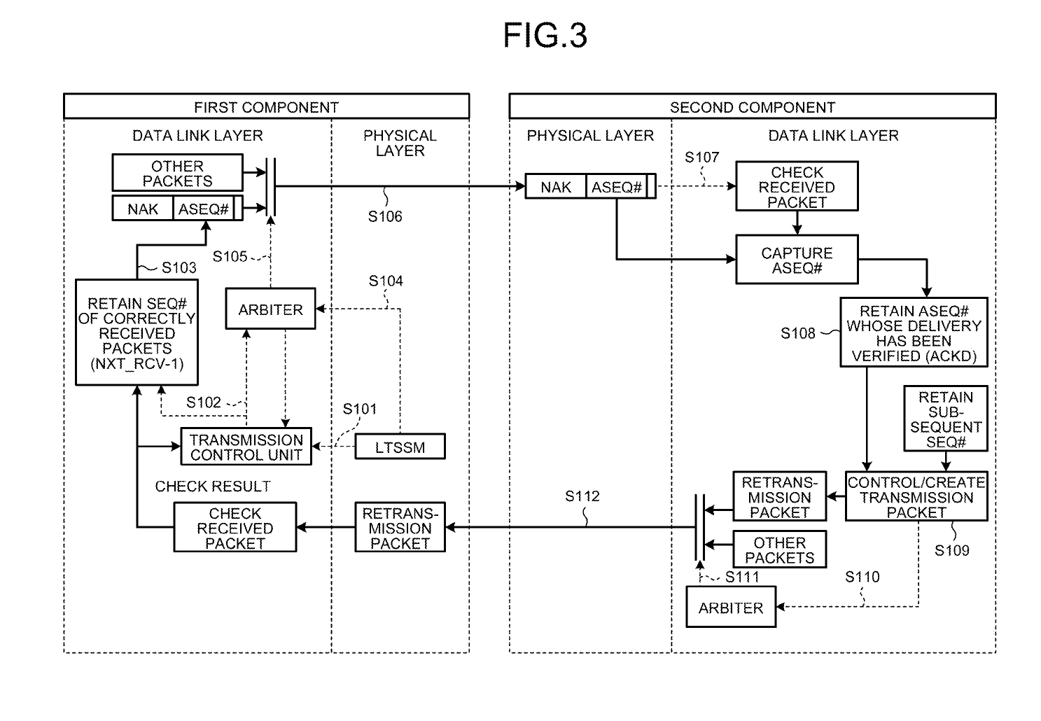

In the following, a process will be described that starts with reinitializing the physical layer and end with restarting packet transmission. FIG. 3 is a schematic diagram illustrating the flow of a process from reinitializing to restarting packet transmission according to the first embodiment.

As illustrated in FIG. 3, the data link layer in the first component 10 checks a received packet, retains the sequence number (SEQ #) of the packet that has been correctly received, and manages the NXT_RCV that is the SEQ # to be subsequently received.

In this state, in the physical layer in the first component 10, if the LTSSM 11 starts to reinitialize the physical layer, the LTSSM 11 notifies the transmission control unit 14 that the reinitialization has started (Step S101).

In the data link layer in the first component 10, the transmission control unit 14 notifies, during the reinitialization of the physical layer, the packet creating unit 15 and the arbiter 16 that the reinitialization of the physical layer has started (Step S102). Then, the packet creating unit 15 creates a NAK in which a value obtained by subtracting 1 from the NXT_RCV is stored in the aseq # (Step S103).

Thereafter, when the LTSSM 11 ends the reinitialization of the physical layer, the LTSSM 11 notifies the arbiter 16 that the reinitialization has ended (Step S104).

Then, the arbiter 16, which received the notification indicating that the reinitialization has ended, controls transmission such that the NAK is transmitted with priority over other packets (Step S105) and the transmitting unit 17 transmits the NAK to the second component 30 (Step S106).

In the second component 30, the receiving unit 32 in the physical layer receives the NAK; the packet checking unit 33 in the data link layer in the second component 30 extracts the aseq # from the NAK (Step S107); and the delivery verifying unit 34 retains the extracted aseq # (Step S108).

Then, the packet creating unit 35 creates a retransmission packet on the basis of the extracted aseq # (Steps S109 and S110). Then, the arbiter 36 controls transmission such that the retransmission packet is transmitted with priority over other packets (Step S111) and the transmitting unit 37 transmits the retransmission packet to the first component 10 (Step S112).

Flow of a Process

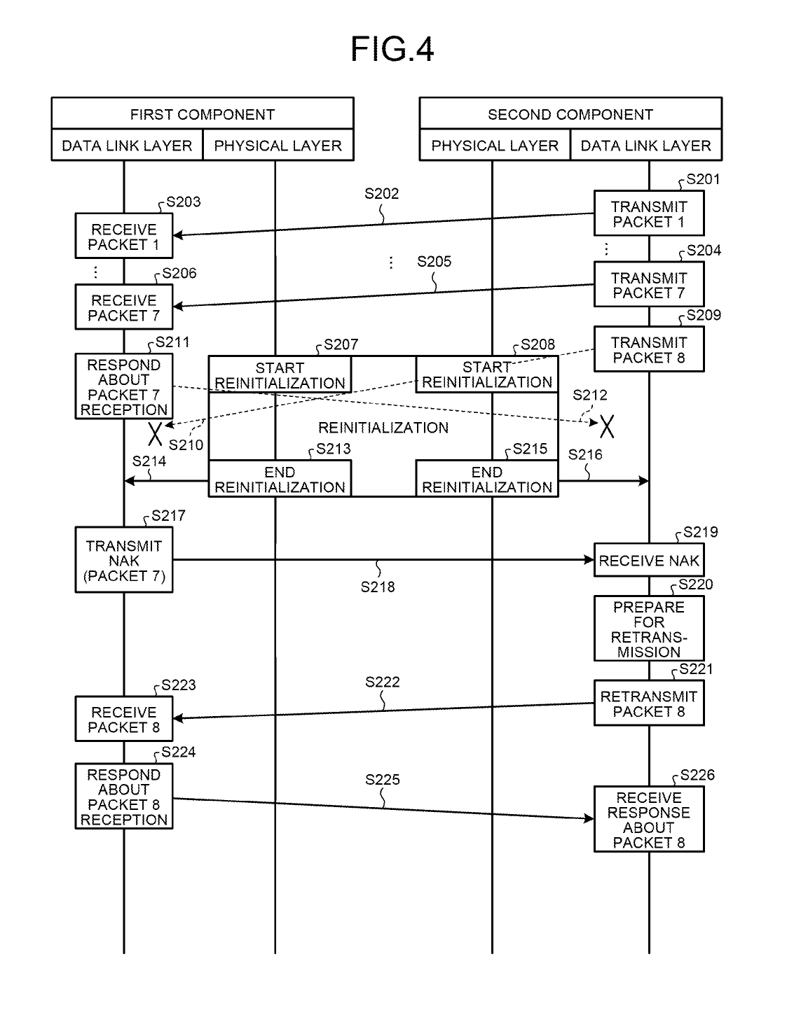

FIG. 4 is a sequence diagram illustrating the flow of a process according to the first embodiment. Hereinafter, the packet with the sequence number of N is referred to as packet N.

As illustrated in FIG. 4, a packet 1 is transmitted from the data link layer in the second component 30 to the first component 10 via the physical layers (Steps S201 and S202). The data link layer in the first component 10 receives the packet 1 via the physical layer (Step S203). The data link layer in the first component 10 sends, as a response to the second component 30, an ACK associated with the packet 1.

Similarly, the packets from a packet 2 to a packet 6 are transmitted from the second component 30 to the first component 10. Then, a packet 7 is transmitted from the data link layer in the second component 30 to the first component 10 via the physical layers (Steps S204 and S205). The data link layer in the first component 10 receives the packet 7 via the physical layer (Step S206).

After the packet 7 has been transmitted and received, a malfunction of the lanes 5 or the like is detected. Consequently, reinitialization of the physical layer is started both in the physical layers in the first component 10 and the second component 30 (Steps S207 and S208).

Then, a packet 8 is transmitted from the data link layer in the second component 30 before a notification is sent that the reinitialization has started (Step S209); however, because the reinitialization is being performed in the physical layer, the packet 8 is not delivered to the first component 10 (Step S210). At this point, in the second component 30, because the packets up to the packet 8 have been transmitted, “9” is retained as the NXT_TR.

Similarly, before a notification is sent that the reinitialization has started, an acknowledgement (ACK) of the packet 7 received at S206 is transmitted from the data link layer in the first component 10 (Step S211). However, because reinitialization is being performed in the physical layer, the acknowledgement of the packet 7 is not delivered to the second component 30 (Step S212). At this point, because the first component 10 has already received packets up to the packet 7, the first component 10 stores “8” as the NXT_RCV.

Thereafter, after the reinitialization of the physical layer ends, a notification of the completion of the reinitialization is transmitted from the physical layer to the data link layer in the first component 10 (Steps S213 and S214). Similarly, when the reinitialization of the physical layer ends, a notification of the completion of the reinitialization is transmitted from the physical layer to the data link layer in the second component 30 (Steps S215 and S216).

Then, after the end of the reinitialization, because the second component 30 has no unsent packets, no process is performed.

In contrast, because the data link layer in the first component 10 retains “8” as the NXT_RCV, the first component 10 transmits, to the second component 30, a NAK with which restarting of the transmission from the packet 8 is requested (Steps S217 and S218). Specifically, the first component 10 transmits, to the second component 30, a retransmission request that contains aseq #=7, indicating that packets up to the packet 7 have already been received.

Then, the data link layer in the second component 30 receives the NAK (Step S219) and prepares the retransmission (Step S220). Specifically, the second component 30 extracts aseq #=7 from the NAK and prepares for retransmitting the packet 8, whose sequence number is “8”.

In this way, the second component 30 retransmits the packet 8 to the first component 10 and updates the NXT_TR to “9” (Steps S221 and S222). The first component 10 receives the retransmitted packet 8 and updates the NXT_RCV to “9” (Step S223).

Subsequently, the first component 10 transmits, to the second component 30, a response with respect to the packet 8 (Steps S224 and S225) and the second component 30 receives the acknowledgement and updates the ACKD to “8” (Step S226). Thereafter, packet transmission is performed normally.

As described above, in the information processing apparatus 1, after the transmission and the reception of a packet between the components is stopped due to the reinitialization of the physical layer, it is possible to send a notification indicating a restart time point from the reception side to the transmission side, thereby reducing the delay time of the packet. For example, in FIG. 4, if a method according to the first embodiment is used, an expected packet can be transmitted after the NAK is forwarded after the restarting of the transmission. In contrast, if the conventional technology is used, the second component continues to sequentially transmit the packets from the packet 8 and the subsequent packets until the second component becomes aware that it has not received an ACK associated with the packet 7.

Consequently, in the conventional technology, the reception side can receive an expected packet after the time period of “packet transfer time+ACK transfer time+replay time-out time+retransmission packet transfer time” has elapsed. In contrast, in the first embodiment, the reception side can receive an expected packet after the time period of “NAK transfer time+retransmission packet transfer time” has elapsed. In this way, the information processing apparatus 1 can reduce the delay time for a packet, thus reducing degradation of performance.

### [b] Second Embodiment

In the first embodiment, a description has been given of a case in which, after the reinitialization, the first component 10 notifies the second component 30 of a time point at which packet transmission is restarted; however, the embodiment is not limited thereto. For example, the first component 10 may also notifies, during the reinitialization, the second component 30 of a time point at which the packet transmission is restarted.

Accordingly, in the second embodiment, a description will be given of an example in which the first component 10 notifies the second component 30 of a time point at which the packet transmission t is restarted during the reinitialization. The overall configuration in the second embodiment is the same as that in the first embodiment; therefore, a description thereof in detail will be omitted.

Configuration of the Information Processing Apparatus

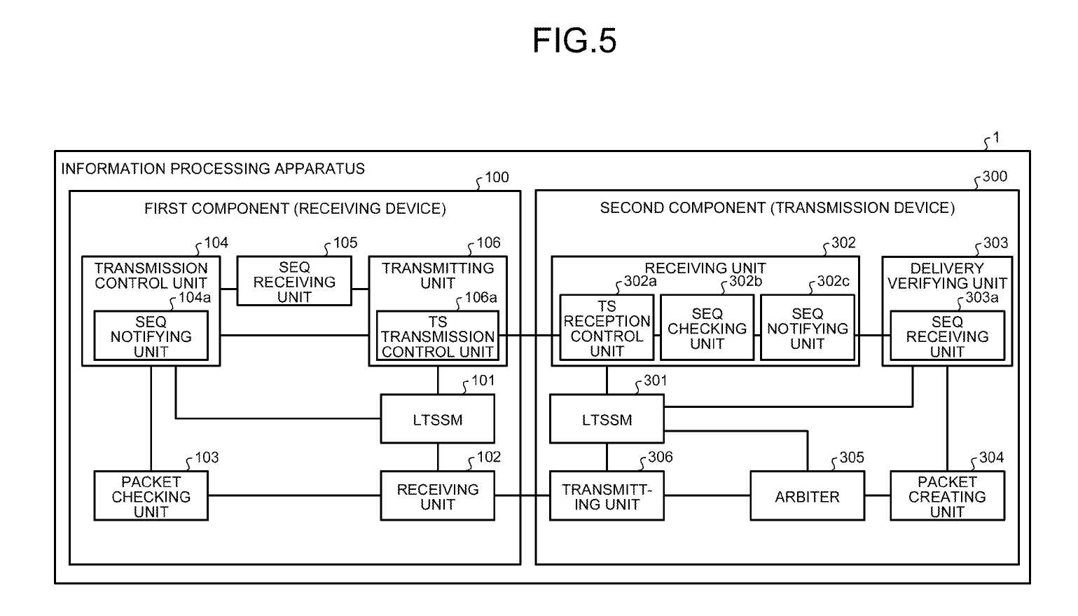

FIG. 5 is a block diagram illustrating the configuration of an information processing apparatus according to a second embodiment. In the following, a description will be given of a first component 100 and a second component 300.

Configuration of the First Component

As illustrated in FIG. 5, the first component 100 includes an LTSSM 101, a receiving unit 102, a packet checking unit 103, a transmission control unit 104, an SEQ receiving unit 105, and a transmitting unit 106. Each processing unit is implemented by, for example, hardware. The LTSSM 101, the receiving unit 102, the SEQ receiving unit 105, and the transmitting unit 106 correspond to the physical layer. The packet checking unit 103, and the transmission control unit 104 correspond to the data link layer.

Similarly to the LTSSM 11 described in the first embodiment, the LTSSM 101 executes reinitialization of the physical layer of the transmission path. In the second embodiment, the LTSSM 101 notifies the receiving unit 102, the transmission control unit 104, and the transmitting unit 106 that the reinitialization has started and executes the reinitialization using a training sequence (TS).

The receiving unit 102 receives packets that have been transmitted by the second component 300. The receiving unit 102 receives a packet via each of the lanes 5 and outputs the received packet to the packet checking unit 103. Furthermore, the receiving unit 102 receives messages, such as a TS 1 and a TS 2, in the training sequence for a predetermined number of times and outputs the messages to the LTSSM 101.

Similarly to the packet checking unit 13 described in the first embodiment, the packet checking unit 103 determines whether packets are received normally. Specifically, the packet checking unit 103 manages, as NXT_RCV, the sequence number of a packet that is expected to be subsequently received and determines whether packets are sequentially received.

The transmission control unit 104 includes an SEQ notifying unit 104a and controls transmission of packets. For example, the transmission control unit 104 creates an ACK on the basis of the result check performed by the packet checking unit 103 until a notification is received from the LTSSM 101 indicating that the reinitialization has started and the transmission control unit 104 then outputs the ACK to the transmitting unit 106. Furthermore, the transmission control unit 104 also performs the same process after a notification is received from the LTSSM 101 indicating that the reinitialization has ended.

The SEQ notifying unit 104a notifies the SEQ receiving unit 105 of the latest sequence number from among the packets that have been received normally. For example, if the SEQ notifying unit 104a receives, from the LTSSM 101, a notification indicating that the reinitialization has started, the SEQ notifying unit 104a acquires NXT_RCV from the packet checking unit 103. Then, the SEQ notifying unit 104a notifies, as an SEQ value during the reinitialization, the SEQ receiving unit 105 of the value obtained by subtracting 1 from the value of NXT_RCV.

The SEQ receiving unit 105 receives the SEQ value from the SEQ notifying unit 104a and notifies the transmitting unit 106 of the SEQ value. Specifically, the SEQ receiving unit 105 retains, during the reinitialization of the physical layer, the sequence number of the latest packets that have been received normally before the reinitialization is started and notifies the transmitting unit 106 of the sequence number.

The transmitting unit 106 includes a TS transmission control unit 106a and performs packet transmission. For example, if the transmitting unit 106 receives an ACK from the transmission control unit 104, the transmitting unit 106 transmits the ACK to the second component 300.

The TS transmission control unit 106a transmits the TS 1 or the TS 2 when the physical layer is reinitialized. Specifically, if the TS transmission control unit 106a receives a notification from the LTSSM 101 indicating that the reinitialization has started, the TS transmission control unit 106a transmits the TS 1 to the second component 300 for a predetermined number of times. Then, the TS transmission control unit 106a creates the TS 2, which contains the SEQ value received from the SEQ receiving unit 105 as the aseq #, and transmits the TS 2 to the second component 300 for the predetermined number of times. Specifically, the TS transmission control unit 106a adds the SEQ value to the TS 2, which is exchanged during the reinitialization of the physical layer, and transmits the TS 2 via each of the lanes 5 to the second component 300.

Configuration of the Second Component

As illustrated in FIG. 5, the second component 300 includes an LTSSM 301, a receiving unit 302, a delivery verifying unit 303, a packet creating unit 304, an arbiter 305, and a transmitting unit 306. Each processing unit is implemented by, for example, hardware. The LTSSM 301, the receiving unit 302, and the transmitting unit 306 correspond to the physical layer. The delivery verifying unit 303, the packet creating unit 304, and the arbiter 305 correspond to the data link layer.

Similarly to the LTSSM 101, the LTSSM 301 manages a link between the first component 100 and the second component 300 and performs the reinitialization of the physical layer for the transmission path. Furthermore, the LTSSM 301 notifies the receiving unit 302, the arbiter 305, and the transmitting unit 306 that the reinitialization has started or ended.

The receiving unit 302 includes a TS reception control unit 302a, an SEQ checking unit 302b, and an SEQ notifying unit 302c and receives the TS 1 or the TS 2. Furthermore, the receiving unit 302 receives an ACK from the first component 100.

The TS reception control unit 302a receives the TSs from the first component 100 when the initialization is performed. For example, the TS reception control unit 302a receives the TS 1 via each of the lanes 5 and outputs the TS 1 to the LTSSM 301. Furthermore, the TS reception control unit 302a receives the TS 2 via each of the lanes 5 and outputs the TS 2 to the SEQ checking unit 302b.

The SEQ checking unit 302b extracts the aseq # from the TS 2 every time the TS 2 is received by the TS reception control unit 302a and then checks the sequence number against the sequence numbers that have already been received. For example, the SEQ checking unit 302b extracts, for each of the lanes 5, a value of the aseq # from the TS 2 and determines whether the value of the aseq # is the same as that previously extracted. Then, the SEQ checking unit 302b determines whether each of the lanes 5 has received the same value of the aseq # several times and outputs the determination result to the SEQ notifying unit 302c.

The SEQ notifying unit 302c notifies the delivery verifying unit 303 of the value of the aseq # extracted from the TS 2. For example, the SEQ notifying unit 302c receives information on the lane 5 that has contained the same value of the aseq # several times as determined by the SEQ checking unit 302b. Then, the SEQ notifying unit 302c specifies the lane with the lowest number from among the received lanes and notifies the delivery verifying unit 303 of the value of the aseq # that was contained in the TS 2 received at the specified lane.

The delivery verifying unit 303 includes an SEQ receiving unit 303a and determines whether the transmitted packet has been received normally. Specifically, similarly to the delivery verifying unit 34 described in the first embodiment, the delivery verifying unit 303 determines whether the packet that was transmitted due to the reception of an ACK or the like is received normally. Furthermore, the delivery verifying unit 303 manages, as an ACKD, the sequence number of the latest packet whose transmission has been verified and then outputs, to the packet creating unit 304, an instruction to create a packet on the basis of the ACKD.

The SEQ receiving unit 303a receives, from the SEQ notifying unit 302c, a value of the aseq #, i.e., the latest sequence number that has been received. For example, if the SEQ receiving unit 303a receives, from the SEQ notifying unit 302c, a notification that the aseq # is “5”, the SEQ receiving unit 303a determines that packets up to a packet with the sequence number “5” have been received normally. Then, the SEQ receiving unit 303a updates the ACKD managed by the delivery verifying unit 303 to “5”. Consequently, the delivery verifying unit 303 outputs, to the packet creating unit 304, an instruction to re-create a packet with the sequence number “6”, which is obtained by adding 1 to the ACKD.

The packet creating unit 304 then creates a packet and outputs the packet to the arbiter 305. Specifically, similarly to the packet creating unit 35, the packet creating unit 304 creates a retransmission packet or a normal packet. For example, if the packet creating unit 304 receives, from the delivery verifying unit 303, a sequence number and an instruction to re-create a packet, the packet creating unit 304 creates a retransmission packet that contains the subject sequence number.

Similarly to the arbiter 36, the arbiter 305 controls transmission of the packets that have been created by the packet creating unit 304. Specifically, the arbiter 305 controls transmission, during the reinitialization of the physical layer, such that the retransmission packet created by the packet creating unit 304 is transmitted with priority.

The transmitting unit 306 transmits the packet to the first component 100. For example, the transmitting unit 306 transmits, to the first component 100, the packet that has been output by the arbiter 305.

### Specific Example

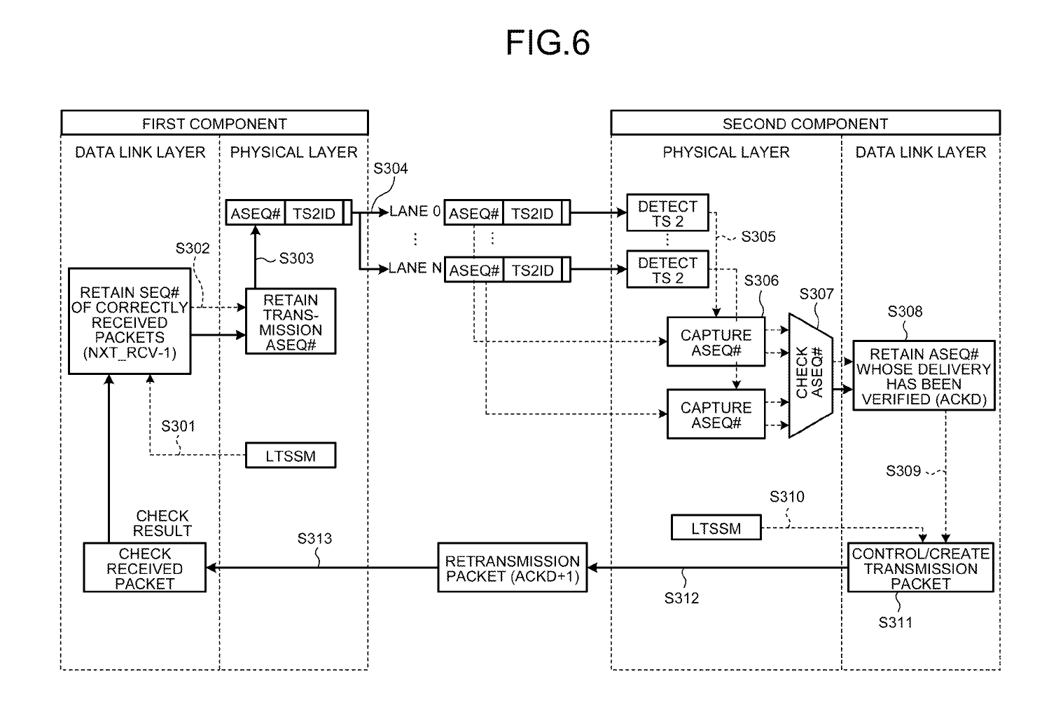

In the following, a process will be described that starts with reinitializing the physical layer and end with restarting packet transmission according to the second embodiment will be described. FIG. 6 is a schematic diagram illustrating the flow of a process from reinitializing to restarting packet transmission according to the second embodiment.

As illustrated in FIG. 6, the data link layer in the first component 100 checks a received packet, retains the sequence number (SEQ #) of the packet that has been correctly received, and manages the NXT_RCV that is the SEQ # to be subsequently received.

In this state, in the physical layer in the first component 100, if the LTSSM 101 starts to reinitialize the physical layer, the LTSSM 101 notifies the transmission control unit 104 that the reinitialization has started (Step S301).

Then, the transmission control unit 104 in the data link layer in the first component 100 notifies the SEQ receiving unit 105 in the physical layer of a value, as an SEQ value, obtained by subtracting 1 from the value of the NXT_RCV. Then, the SEQ receiving unit 105 retains the value as a value of the aseq # for transmission (Step S302).

Subsequently, the TS transmission control unit 106a in the physical layer adds the value of the aseq # acquired from the SEQ receiving unit 105 to the TS 2 that is transmitted when reinitialization is performed in the physical layer (Step S303) and then the value is transmitted via each of the lanes 5 (Step S304).

Then, the TS reception control unit 302a in the physical layer in the second component 300 receives the TS 2 via each of the lanes 5 (Step S305). Subsequently, the SEQ checking unit 302b in the physical layer captures the aseq # from the TS 2 in each of the lanes 5 (Step S306) and checks the sequence number that has already been received (Step S307).

Thereafter, the SEQ receiving unit 303a in the data link layer in the second component 300 receives the aseq # from the SEQ notifying unit 302c in the physical layer and retains the aseq # (Step S308) and instructs that a packet be created in accordance with the aseq # (Step S309).

Then, if the packet creating unit 304 receives, from the LTSSM 301, a notification that the reinitialization of the physical layer ends (Step S310), the packet creating unit 304 creates a retransmission packet on the basis of the aseq # (Step S311). Then, the arbiter 305 controls the transmission such that the retransmission packet is transmitted with priority over other packets (Step S312).

As described above, the first component 100 can receive a packet associated with a value obtained by adding 1 to the ACKD that is managed by the second component 300, i.e., receive a packet from an expected packet after the packet transmission is restarted (Step S313).

Flow of a Process

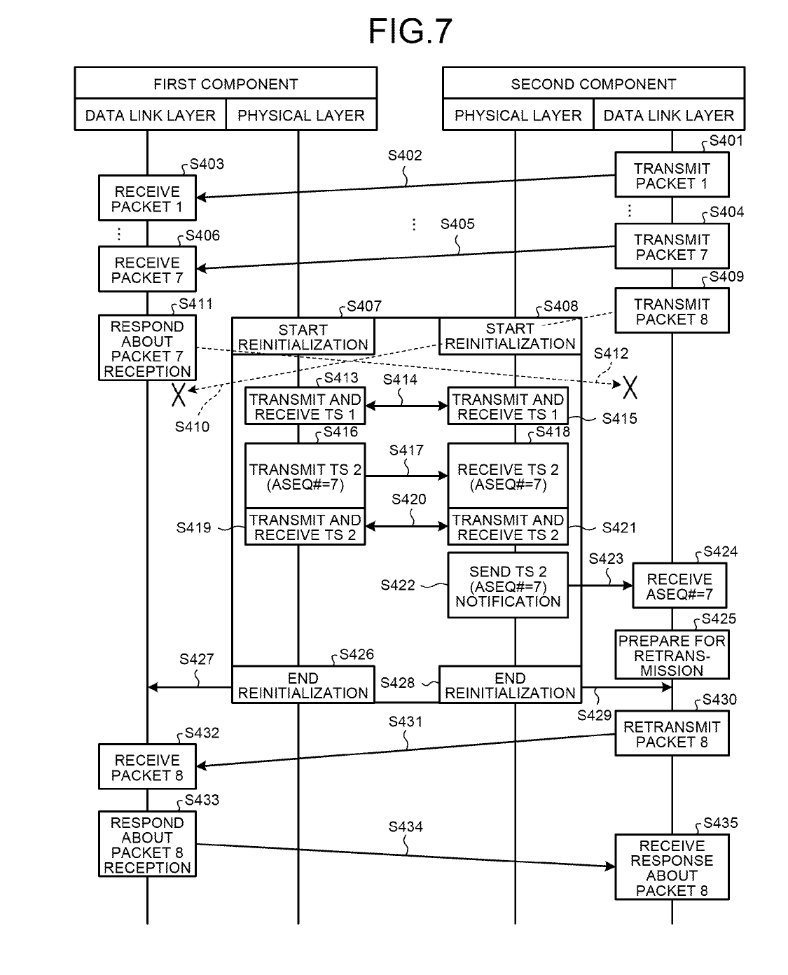

FIG. 7 is a sequence diagram illustrating the flow of a process according to the second embodiment. Hereinafter, the packet with the sequence number of N is referred to as a packet N.

As illustrated in FIG. 7, the packet 1 is transmitted from the data link layer in the second component 300 to the first component 100 via the physical layers (Steps S401 and S402). The data link layer in the first component 100 receives the packet 1 via the physical layer (Step S403). The data link layer in the first component 100 sends a response containing an ACK associated with the packet 1 to the second component 300.

Similarly, the packets from the packet 2 to the packet 6 are transmitted from the second component 300 to the first component 100. Then, the packet 7 is transmitted from the data link layer in the second component 300 to the first component 100 via the physical layers (Steps S404 and S405). The data link layer in the first component 100 receives the packet 7 via the physical layers (Step S406).

After the packet 7 has been transmitted and received, a malfunction of the lanes 5 or the like is detected. Consequently, reinitialization of the physical layer is started both in the physical layers in the first component 100 and the second component 300 (Steps S407 and S408).

Then, the packet 8 is transmitted from the data link layer in the second component 300 before a notification is sent that the reinitialization has started (Step S409); however, because the reinitialize is being performed in the physical layer, the packet 8 is not delivered to the first component 100 (Step S410). At this point, in the second component 300, because the packets up to the packet 8 have been transmitted, “9” is retained as the NXT_TR.

Similarly, before a notification is sent indicating that the reinitialization has started, an acknowledgement (ACK) of the packet 7 received at S406 is transmitted from the data link layer in the first component 100 (Step S411). However, because reinitialization is being performed in the physical layer, the acknowledgement of the packet 7 is not delivered to the second component 300 (Step S412). At this point, because the first component 100 has already received packets up to the packet 7, the first component 100 stores “8” as the NXT_RCV.

In contrast, if initialization has started, the TS 1 is transmitted and received a predetermined number of times between the physical layer in the first component 100 and the physical layer in the second component 300 (Steps S413 to S415). If transmission and reception of the TS 1 have ended normally, the physical layer in the first component 100 transmits, to the second component 300, the TS 2 that contains aseq #=7 (Steps S416 and S417) and the physical layer in the second component 300 receives the TS 2 (Step S418). Specifically, because the first component 100 retains “8” as the NXT_RCV, in order to request restarting packet transmission starting from the packet 7, the first component 100 transmits, to the second component 300, a request for retransmission that contains aseq #=7, which indicate that packets up to the packet 7 have already been received.

Then, similarly to the TS 1, the TS 2 containing aseq #=7 is transmitted and received the same predetermined number of times as the TS 1 between the physical layers in the first component 100 and a second component 200 (Steps S419 to S421). Then, if the TS 2 is transmitted and received normally, the physical layer in the second component 300 transmits, to the data link layer, aseq #=7 extracted from the TS 2 (Step S422 and S423) and the data link layer in the second component 300 receives aseq #=7 (Step S424).

Then, the data link layer in the second component 300 prepares the retransmission in accordance with the received aseq #=7 (S425). Specifically, the second component 300 updates the ACKD to “7” in accordance with aseq #=7. Then, because the second component 300 retains “7” as the ACKD, the second component 300 prepares for retransmitting the packet 8, whose sequence number is “8”.

Then, after the reinitialization of the physical layer ends, a notification of the completion of the reinitialization is transmitted from the physical layer to the data link layer in the first component 100 (Steps S426 and S427). Similarly, when the reinitialization of the physical layer ends, a notification of the completion of the reinitialization is transmitted from the physical layer to the data link layer in the second component 300 (Steps S428 and S429).

Then, when the reinitialization ends, the second component 300 retransmits, to the first component 100, the packet 8 that was prepared for retransmission (Steps S430 and S431) and the first component 100 receives the retransmitted packet 8 (Step S432). At this point, because the first component 100 retains “8” as the NXT_RCV, the first component 100 receives the retransmitted packet 8 without discarding the packet 8. The first component 100 then updates the NXT_RCV to “9”.

Subsequently, the first component 100 transmits, to the second component 300, an acknowledgement with respect to the retransmitted packet 8 (Steps S433 and S434) and the second component 300 receives the acknowledgement and updates the ACKD to “8” (Step S435). Thereafter, packet transmission is performed normally.

Reinitializing Process

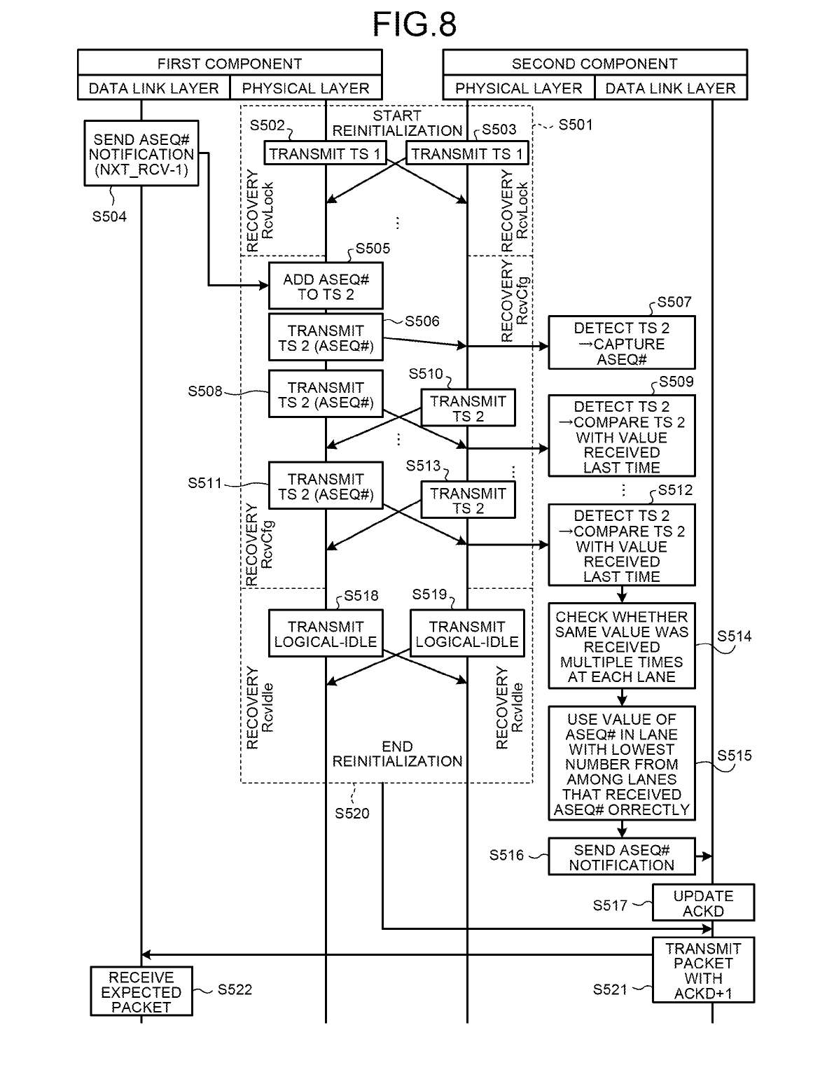

In the following, a reinitializing process according to the second embodiment will be specifically described. FIG. 8 is a schematic diagram specifically illustrating a reinitializing process according to the second embodiment.

As illustrated in FIG. 8, if reinitialization of the physical layer is started between the first component 100 and the second component 300 (Step S501), in a Recovery RcvLock phase, the TS 1 is transmitted and received between the physical layers a predetermined number of times (Steps S502 and S503).

Then, if the transmission and the reception of the TS 1 end normally, the reinitializing process shifts the phase from the Recovery RcvLock phase to a Recovery RcvCfg phase. In this phase, reinitialization is performed, in the physical layer, by transmitting and receiving the TSs 2, which have the same content, using all of the lanes 5 a predetermined number of times. Furthermore, from the data link layer to the physical layer in the first component 100, a notification indicating the aseq # obtained by subtracting 1 from the NXT_RCV is sent (Step S504). Alternatively, the notification of the aseq # may also be performed in the Recovery RcvLock phase.

In the following, a description will be given, as an example, of a process performed using a single lane; however, the processes at 5505 to 5513 are performed using all of the lanes. Specifically, the physical layer in the first component 100 adds the aseq # contained in the notification to the TS 2 (Step S505) and transmits the TS 2 to the second component 300 (Step S506). The physical layer in the second component 300 captures the aseq # from the TS 2 that was received for the first time (Step S507).

Subsequently, the physical layer in the first component 100 adds the aseq # contained in the notification to the TS 2 that was received for the second time and transmits the TS 2 to the second component 300 (Step S508). The physical layer in the second component 300 extracts the aseq # from the TS 2 that was received for the second time and compares the aseq # received for the second time with that received for the first time to determine whether they have the same value (Step S509). Furthermore, the normal TS 2 is also transmitted from the physical layer in the second component 300 to the first component 100 (Step S510).

As described above, the physical layer in the first component 100 adds the aseq # contained in the notification to the TS 2 and transmits the TS 2 that was received for the N^{th} time (predetermined number of times) to the second component 300 (Step S511). The physical layer in the second component 300 extracts the aseq # from the TS 2 that was received for the N^{th} time, compares the aseq # received for the N^{th} time with that received for the N−1^{th} time, and determines whether they have the same value (Step S512). Furthermore, the normal TS 2 is also transmitted from the physical layer in the second component 300 to the first component 100 (Step S513).

When the transmission and the reception of the TS 2 ends after the predetermined number of times, the physical layer in the second component 300 checks whether the aseq # with the same value was received multiple times at each of the lanes 5 (Step S514) and then uses the value of the aseq # in the lane with the lowest number from among the lanes that received the aseq # correctly (Step S515). Then, the physical layer in the second component 300 transmits, to the data link layer, the value of the aseq # that was used (Step S516) and the data link layer updates the ACKD by using the received value of the aseq # (Step S517).

In contrast, when the transmission and the reception of the TS 2 ends after the predetermined number of times, the reinitializing process shifts from the Recovery RcvCfg phase to the Recovery Rcvldle phase. Then, the Logical-Idle is transmitted and received between each of the physical layers in the first component 100 and the second component 300 (Steps S518 and S519) and the reinitializing process ends (Step S520).

When the reinitializing process ends, the data link layer in the second component 300 restarts the packet transmission. At this point, the data link layer in the second component 300 restarts the packet transmission to the first component 100, starting from the packet having a value obtained by adding 1 to a value of the ACKD (Step S521). Consequently, when the packet transmission that has been suspended due to the reinitialization starts, the first component 100 can start the packet transmission from an expected packet (Step S522). Specifically, the first component 100 can receive a packet with the sequence number that is managed by the NXT_RCV.

As described above, with the information processing apparatus 1 according to the second embodiment, during the reinitialization of the physical layer, it is possible to send a notification indicating a restart time point from the reception side to the transmission side. Consequently, the delay time of the packet can be further reduced when compared with the first embodiment. For example, as can be found by comparing FIG. 4 with FIG. 7, in the second embodiment, immediately after reinitialization has ended, it is possible to restart packet transmission from a packet that is expected by the reception side.

Accordingly, in the conventional technology, the reception side can receive an expected packet after “packet transfer time+ACK transfer time+replay time-out time+retransmission packet transfer time” has elapsed. In contrast, in the first embodiment, the reception side can receive an expected packet after “NAK transfer time+retransmission packet transfer time” has elapsed. Furthermore, in the second embodiment, the reception side can receive an expected packet after “retransmission packet transfer time” has elapsed. In this way, with the information processing apparatus 1 according to the second embodiment, it is possible to further reduce the delay time of a packet, thus further reducing degradation of performance.

### [c] Third embodiment

In the above explanation, a description has been given of the embodiments according to the present invention; however, the embodiments are not limited thereto and can be implemented with various kinds of embodiments other than the embodiments described above. Therefore, another embodiment will be described below.

Transmission and Reception of the Aseq #

In the second embodiment, a description has been given of an example in which the first component 100 on the reception side transmits the TS 2, to which the aseq # is added, to the second component 300 on the transmission side; however, the embodiment is not limited thereto. For example, it may also be possible to add the aseq # to the TS 1 and transmit the TS 1.

Furthermore, in the second embodiment, a description has been given of an example in which the TS 2 is received multiple times from each of the lanes 5 and the TS 2 is checked as to whether the same aseq # is received multiple times; however, the embodiment is not limited thereto. For example, if the TS 2 is transmitted multiple times, the aseq # may also be added at a certain time and then transmitted. For example, if the TS 2 is transmitted 16 times in total, lane information may be transmitted for the first 8 times and the aseq # may be transmitted for the second 8 times.

Furthermore, in the second embodiment, a description has been given of an example in which, from among the lanes that have received the same aseq # multiple times, the aseq # that has been received via the lane with the lowest number is used; however, the embodiment is not limited thereto. For example, it is possible to extract each aseq # from the TS 2 received from each lane 5 and then to determine the aseq # that is to be used depending on the value that is a majority.

System

Of the processes described in the embodiments, the whole or a part of the processes that are mentioned as being automatically performed can also be manually performed, or the whole or a part of the processes that are mentioned as being manually performed can also be automatically performed using known methods. Furthermore, the flow of the processes, the control procedures, the specific names, and the information containing various kinds of data or parameters indicated in the above specification and drawings can be arbitrarily changed unless otherwise stated.

The components of each unit illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions. Furthermore, all or any part of the processing functions performed by each device can be implemented by a CPU and by programs analyzed and executed by the CPU or implemented as hardware by wired logic.

According to an aspect of the embodiment of the present invention, it is possible to reduce degradation of performance.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An electronic device comprising:
a first component; and
a second component, wherein
the first component includes
a receiving unit that receives a packet from the second component,
an information transmitting unit that transmits, to the second component, when setting content related to a physical layer of a transmission path between the first component and the second component is reinitialized, identification information which identifies a packet that is to be received when a packet transmission suspended due to the reinitialization is restarted, and
the second component includes
a transmitting unit that transmits a packet to the first component,
a receiving unit that receives the identification information from the first component, and
a transmission control unit that controls, after the reinitialization has been completed and before the packet transmission is restarted by the transmitting unit, the transmitting unit such that the packet transmission is restarted in accordance with the identification information.

2. The electronic device according to claim 1, wherein, during the reinitialization of the setting content related to the physical layer, the information transmitting unit in the first component adds the identification information to a message that is transmitted and received between the first component and the second component and transmits the message to the second component.

3. The electronic device according to claim 2, wherein
the information transmitting unit in the first component transmits the identification information a predetermined number of times, via each of multiple transmission paths by which the first component and the second component are connected, and
the transmission control unit in the second component selects one transmission path from among the transmission paths from which the same identification information is received and controls the transmitting unit in accordance with the identification information received via the selected transmission path.

4. The electronic device according to claim 1, wherein the information transmitting unit in the first component transmits the identification information to the second component after the reinitialization of the setting content related to the physical layer has completed.

5. An electronic device comprising:
a receiving unit that receives a packet from a component that is connected via a transmission path; and
an information transmitting unit that transmits to the component, when setting content related to a physical layer for the transmission path is reinitialized, identification information which identifies a packet that is to be received when packet transmission suspended due to the reinitialization is restarted.

6. An electronic device comprising:
a transmitting unit that transmits a packet to a component connected via a transmission path;
a receiving unit that receives, from the component, identification information which identifies a packet that is to be received when packet transmission suspended due to the reinitialization is restarted; and
a transmission control unit that controls, after the reinitialization has been completed and before the packet transmission is restarted by the transmitting unit, the transmitting unit such that the packet transmission is restarted in accordance with the identification information.

7. A transmission control method executed by an electronic device that includes a first component that receives a packet and a second component that transmits the packet, the transmission control method comprising:
executing reinitialization of setting content related to a physical layer of a transmission path between the first component and the second component;
transmitting, to the second component when the reinitialization is executed, identification information for identifying a packet that is to be received when packet transmission suspended due to the reinitialize is restarted; and
notifying, after the reinitialization has been completed and before the first component restarts the packet transmission, the first component of an instruction to restart the packet transmission in accordance with the identification information.
